(19) United States
(12) Patent Application Publication
(10) Pub. No.: US 2013/0264351 A1
(43) Pub. Date: Oct. 10, 2013

(54) Product Dispensing System

(71) Applicants: William J. Bogdziewicz, III, Richmond, VA (US); Caleb S. Loftin, Richmond, VA (US); Aaron L. Bates, Moseley, VA (US); John Gelardi, Midlothia, VA (US)

(72) Inventors: William J. Bogdziewicz, III, Richmond, VA (US); Caleb S. Loftin, Richmond, VA (US); Aaron L. Bates, Moseley, VA (US); John Gelardi, Midlothia, VA (US)

(21) Appl. No.: 13/443,157

(22) Filed: Apr. 10, 2012

(51) Int. Cl. A47F 1/04; B65G 59/00; A47F 7/28

(52) U.S. Cl. 221/1; 211/59.2

(57) ABSTRACT

A product dispensing system including a dispenser having a housing that defines an internal volume and a product display area, and a support deck received in the internal volume, the support deck including a front end and a rear end, wherein the front end extends toward the product display area, and wherein the rear end is elevated relative to the front end, a container received in the internal volume and supported on the support deck, the container defining an access opening, wherein the support deck directs the container toward the front end such that the access opening is aligned with the product display area, and a plurality of products initially housed in the container.

### FIELD

This application relates to the dispensing of products from packaging containers and, more particularly, to product dispensers configured to cooperate with packaging containers to dispense products.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them (e.g., on a shelf) to consumers.

Alternatives to the traditional package-ship-unpack-display model have been developed in an effort to improve operating efficiency. For example, U.S. Pat. No. 7,922,437 (issued on Apr. 12, 2011) discloses a product dispensing system that includes a dispenser having a support structure, a product display area and an opening tool. The dispenser may be positioned on a retailer's shelf and loaded with product simply by placing a container comprising multiple units of product onto the support structure of the dispenser. As the container is being placed onto the support structure, the opening tool of the dispenser opens the container in such a manner that products rolls from the container and down to the product display area of the dispenser under the force of gravity.

Unfortunately, many products are not configured to roll, let alone configured to roll in a generally straight line. Therefore, despite the availability of various product dispensing systems, many products are still manually dispensed using the traditional package-ship-unpack-display model.

Accordingly, those skilled in the art continue with research and development efforts in the field of product dispensing systems.

### SUMMARY

In one embodiment, the disclosed product dispensing system may include (1) a dispenser having a housing that defines an internal volume and a product display area, and a support deck received in the internal volume, the support deck including a front end and a rear end, wherein the front end extends toward the product display area, and wherein the rear end is elevated relative to the front end, (2) a container received in the internal volume and supported on the support deck, the container defining an access opening, wherein the support deck directs the container toward the front end such that the access opening is aligned with the product display area, and (3) a plurality of products initially housed in the container.

In another embodiment, the disclosed method for dispensing products may include the steps of (1) providing a plurality of containers, each container housing a plurality of products and defining an access opening, (2) stacking the containers in a dispenser, wherein the dispenser includes a product display area and a support deck, the support deck having a front end and a rear end, wherein the front end extends toward the product display area, and wherein the rear end is elevated relative to the front end, and (3) moving a lower-most container of the plurality of containers onto the support deck, wherein the support deck directs the access opening of the lower-most container to the product display area.

Other embodiments of the disclosed product dispensing system and method will become apparent from the following detailed description, the accompanying drawings and the appended claims.

### BRIEF DESCRIPTION OF THE DRAWINGS

FIG. 1 is a front and side perspective view of one embodiment of the disclosed product dispensing system;

FIG. 2 is a side elevational view of the product dispensing system of FIG. 1;

FIG. 3A is a perspective view of one container of the product dispensing system of FIG. 2, shown in a closed configuration;

FIG. 3B is a perspective view of the container of FIG. 3A, shown in an open configuration;

FIG. 4 is a perspective view of the dispenser of the product dispensing system of FIG. 2;

FIG. 5 is a front and side perspective view of another embodiment of the disclosed product dispensing system;

FIG. 6 is a front and side perspective view of a portion of the product dispensing system of FIG. 5, shown in a first configuration;

FIG. 7 is a front and side perspective view of a portion of the product dispensing system of FIG. 5, shown in a second configuration;

FIG. 8 rear and side perspective view of the product dispensing system of FIG. 7; and

FIG. 9 is a front and side perspective view of a portion of the product dispensing system of FIG. 5, shown in a third configuration.

### DETAILED DESCRIPTION

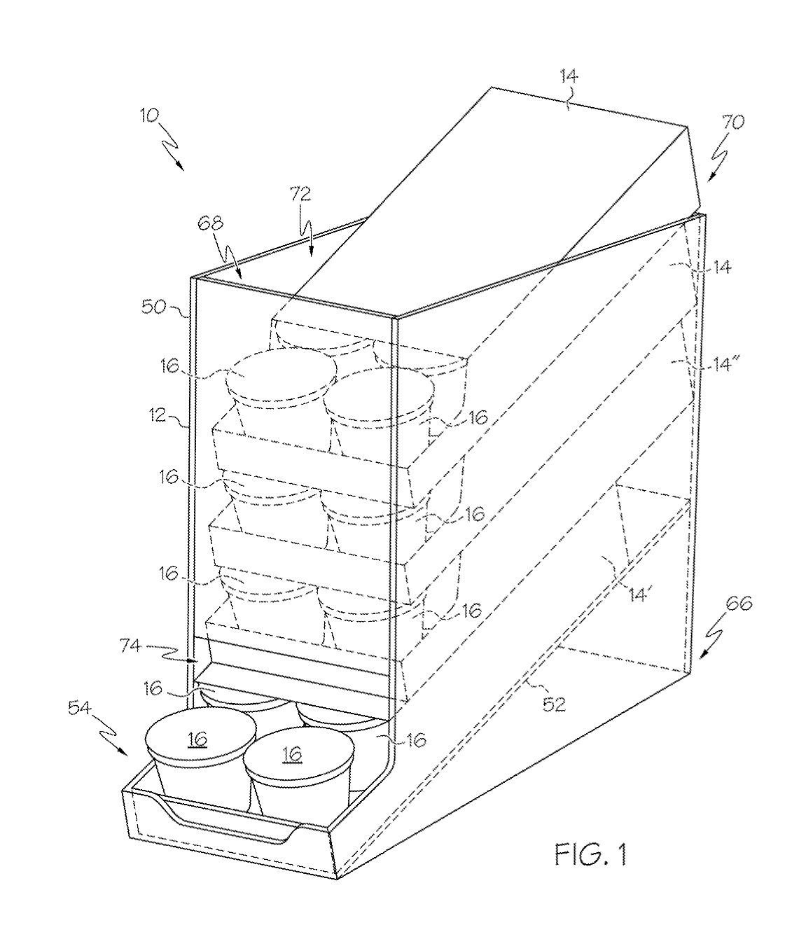

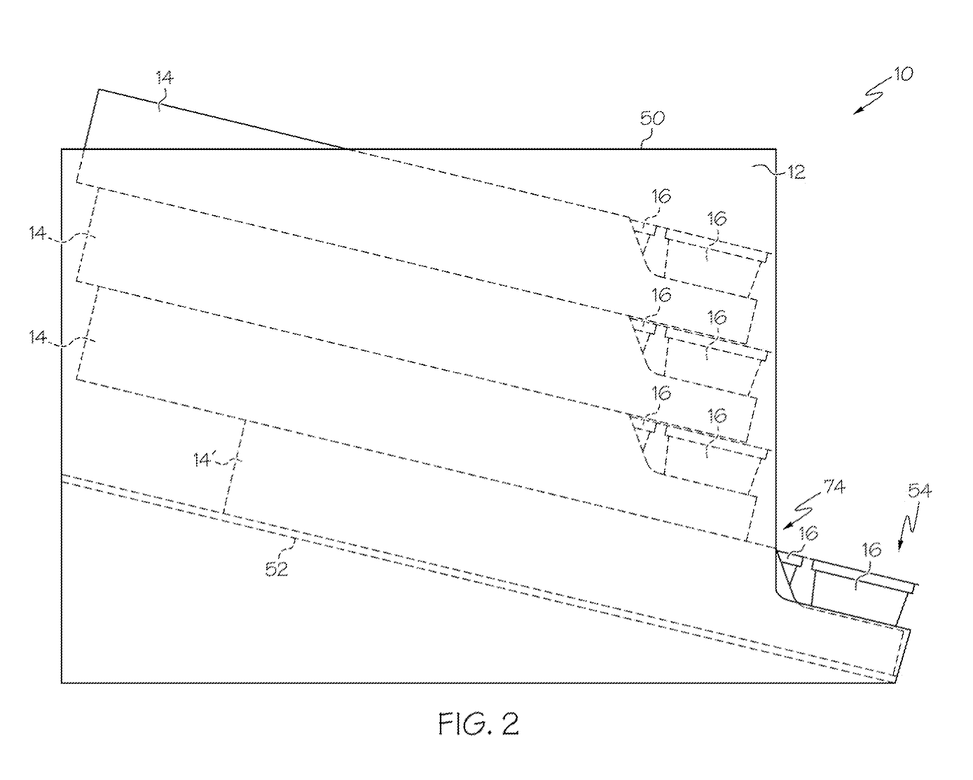

Referring to FIGS. 1 and 2, one embodiment of the disclosed product dispensing system, generally designated 10, may include a dispenser 12, a plurality of containers 14 and a plurality of products 16. Each container 14 may house an initial quantity of products 16, and may be loaded into the dispenser 12. The dispenser 12 may dispense the products 16 directly from the containers 14.

The containers 14 may be any containers capable of housing products 16 and being housed within the dispenser 12. For example, the containers 14 may be paperboard cartons, corrugated boxes or the like.

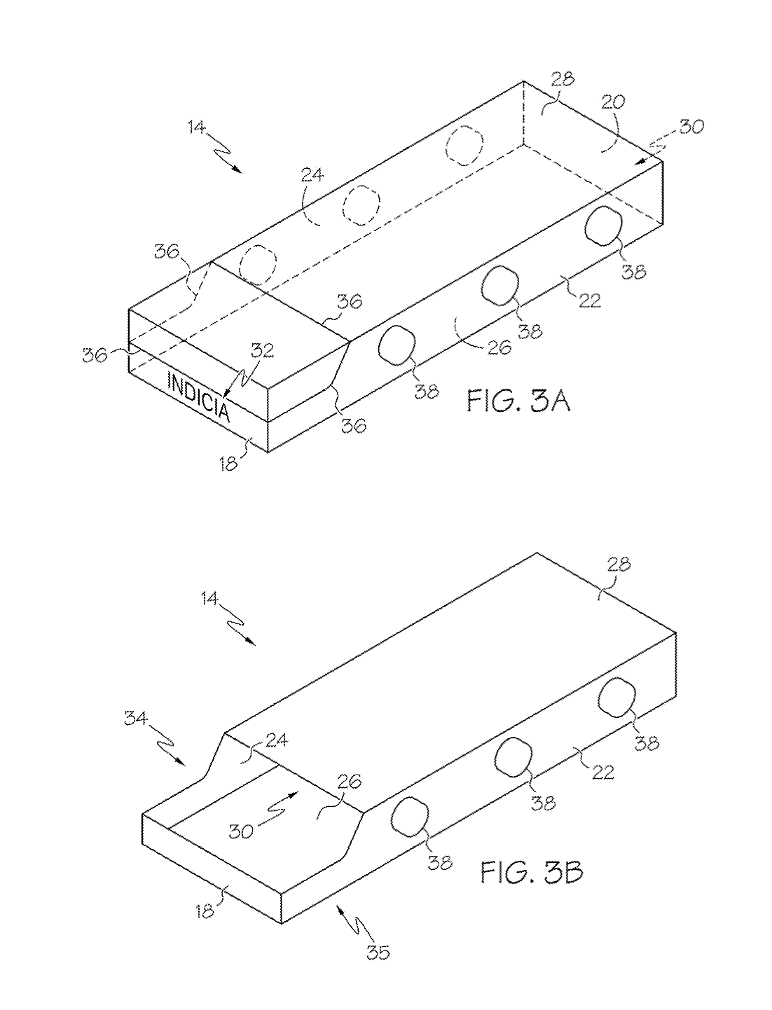

Referring to FIG. 3A, each container 14 may be a generally rectilinear container having six walls 18, 20, 22, 24, 26, 28 that define an internal volume 30 for receiving the products 16 (the products 16 are shown in FIGS. 1 and 2). Opposed walls 18 and 20 may define the front and rear walls, respectively, of the container 14. Opposed walls 22 and 24 may define the first (e.g., right) and second (e.g., left) side walls, respectively, of the container 14. Opposed walls 26 and 28 may define the base and upper walls, respectively, of the container 14. Containers of other shapes and configurations are also contemplated.

At least one major surface of the container 14 may be marked with indicia 32, such as printed text and/or graphics. For example, the front wall 18 of the container 14 may be marked with indicia 32 indicative of the products 16 housed within the internal volume 30 of the container 14.

Referring to FIG. 3B, an access opening 34 may be formed proximate the front end 36 of the container 14 to provide access to the internal volume 30 of the container 14. For example, the access opening 34 may be formed in the front 18, side 22, 24 and upper 28 walls of the container 14. The access opening 34 may be sized and shaped to allow the products 16 housed in the container 14 to pass therethrough.

In one expression, the access opening 34 may be pre-formed in the container 14. Optionally, a peelable label or the like (not shown) may be applied to the container 14 over the pre-formed access opening 34. Therefore, the access opening 34 may be revealed by peeling away the optional peelable label from the container 14 prior to loading the container 14 into the dispenser 12.

In another expression, the access opening 34 may be defined by pre-formed weakening features 36, such as perforations or zipper strips, formed in the walls 18, 22, 24, 28 of the container 14, as shown in FIG. 3A. Therefore, the access opening 34 may be formed by separating a portion of the container 14 along the pre-formed weakening features 36 prior to loading the container 14 into the dispenser 12.

As shown in FIGS. 3A and 3B, each container 14 may optionally include one or more ventilation openings 38. The ventilation openings 38 may encourage air flow within the container 14, which may be particularly advantageous when the container 14 houses products 16, such as yogurt cups, that require refrigeration.

Various products 16 may be housed in the containers 14 and dispensed by the dispenser 12. Since the products 16 will be dispensed directly from the containers 14 and, therefore, will not roll though the dispenser as in prior art product dispensing systems, the products need not be capable or rolling. For example, the products 16 may be cups (e.g., yogurt cups), cans (e.g., canned food), jars (e.g., jarred sauce), bottles (e.g., bottled soft drinks), wrapped or bagged packages (e.g., individual snack packs).

The products 16 may be arranged in rows within the container 14. For example, the products 16 may be arranged in two side-by-side rows, as shown in FIG. 1. Containers 14 housing only one row, or three or more rows, of products 16 are also contemplated.

While the product dispensing system 10 is shown in FIGS. 1 and 2 having four containers 14, with each container 14 housing an initial quantity (e.g., twelve) products 16, those skilled in the art will appreciate that varying the number of containers 14 and/or the quantity of products 16 housed within the containers 14 will not depart from the scope of the present disclosure.

Referring to FIGS. 1, 2 and 4, the dispenser 12 may include a housing 50 and a support deck 52. The housing 50 may be sized and shaped to receive the containers 14, and may define a product display area 54. The support deck 52 may be received within the housing 50, and may direct the containers 14 and associated products 16 toward the product display area 54. Therefore, containers 14 may be loaded into the dispenser 12 and consumers may retrieve products 16 from the containers 14 by way of the product display area 54.

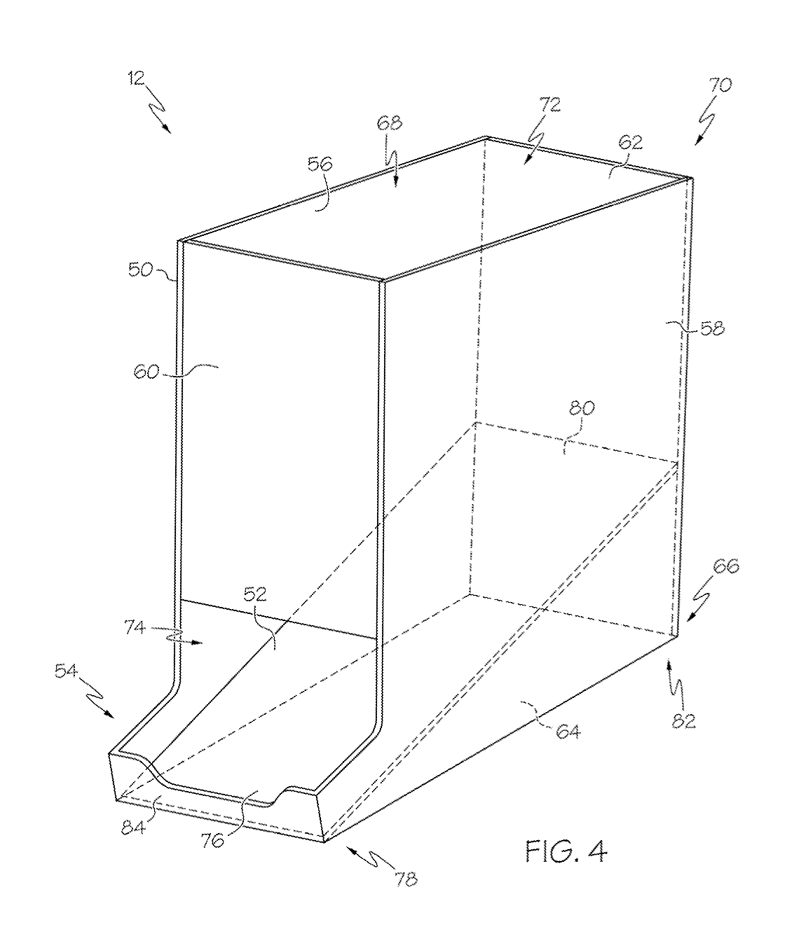

Referring to FIG. 4, the housing 50 of the dispenser 12 may include a first (e.g., left) side wall 56, a second (e.g., right) side wall 58, a front wall 60 and a rear wall 62. The left side wall 56 may be laterally spaced from the right side wall 58, and may be generally parallel with the right side wall 58. The front wall 60 may be longitudinally spaced from the rear wall 62, and may be generally parallel with the rear wall 62. Optionally, the housing 50 may further include a base wall 64 that may enclose, at least partially, the lower portion 66 of the housing 50.

The side walls 56, 58, the front wall 60 and the rear wall 62 may define an internal volume 68 of the housing 50. The internal volume 68 may be sized and shaped to receive a plurality of containers 14 (e.g., four containers 14) in a stacked and slightly angled configuration, as shown in FIGS. 1 and 2.

The upper portion 70 of the housing 50 may define a container loading opening 72 that may open to the internal volume 68 of the housing 50. For example, the container loading opening 72 may be defined by the upper portions 70 of the side walls 56, 58, the front wall 60 and the rear wall 62. Therefore, containers 14 may be loaded into the internal volume 68 of the housing 50 by way of the container loading opening 72.

The lower portion 66 of the housing 50 may define a container dispensing opening 74 that opens to the internal volume 68 of the housing 50 proximate the product display area 54. For example, the container dispensing opening 74 may be defined by the lower portions 66 of the front wall 60 and the side walls 56, 58. Therefore, a container 14, or at least a portion of a container 14, may move from the internal volume 68 of the housing 50 to the product display area 54 by way of the container dispensing opening 74, as shown in FIGS. 1 and 2.

Still referring to FIG. 4, the support deck 52 of the dispenser 12 may be received in the internal volume 68 of the housing 50. The support deck 52 may laterally extend between the left and right side walls 56, 58, and may include a front end 76 that longitudinally extends toward the front end 78 of the housing 50 and a rear end 80 that longitudinally extends toward the rear end 82 of the housing 50.

The support deck 52 may be inclined from the front end 76 to the rear end 80 (i.e., the rear end 80 may be elevated relative to the front end 76). Therefore, containers 14 supported on the support deck 52 may be urged downward toward the front end 76 of the support deck 52 under the force of gravity.

The support deck 52 may be constructed from a relatively low friction material, thereby allowing containers 14 to slide along the support deck 52 down toward the front end 76 of the support deck 52. For example, the support deck 52 may be constructed from a polymeric material, such as polycarbonate, or a metal, such as polished steel.

A stop 84 may be positioned proximate the front end 76 of the support deck 52 to prevent containers 14 from moving beyond the front end 76 of the support deck 52. For example, the stop 84 may laterally extend between the side walls 56, 58 of the housing 50 proximate the lower portion 66 of the housing 50. Therefore, the stop 84 may retain containers 14 proximate the product display area 54 of the housing 50.

While the dispenser 12 is shown in the drawings with a product display area 54 that protrudes longitudinally forward relative to the front wall 60 of the housing 50, various other configurations of the product display area 54 are also contemplated. For example, in one variation, the stop 84 may be generally vertically aligned with the front wall 60 of the housing 50 such that the product display area 54 is housed substantially within the internal volume 68 of the housing 50.

Furthermore, while the dispenser 12 is shown in the drawings with only one product display area 54, dispensers with multiple product display areas are also contemplated. For example, the lower-most container 14′ may be directed to the lower-most product display area 54 and the container 14 immediately above the lower-most container 14′ may be directed to a second product display area (not shown). While not shown in the drawings, product display areas configured to receive two or more containers 14 are also contemplated.

Referring back to FIGS. 1 and 2, the product dispensing system 10 may be assembled by loading a plurality of containers 14 into the internal volume 68 of the housing 50 of the dispenser 12 by way of the container loading opening 72. The containers 14 may be loaded such that they are generally vertically stacked one on top of the next.

If necessary, an access opening 34 (FIG. 3B) may be formed (or otherwise revealed) in each container 14 prior to loading the containers 14 into the dispenser 12, as described in greater detail above.

When the containers 14 are loaded into the internal volume 68 of the housing 50, the lower-most container 14′ may be supported on the support deck 52. Gravity may urge the lower-most container 14′ toward the front end 76 of the support deck 52. Therefore, the lower-most container 14′ (or at least the front end of the lower-most container 14′) may pass through the container dispensing opening 74 to the product display area 54. The other containers 14 within the dispenser 12 may be retained within the internal volume 68 of the housing 50 by the front wall 60.

Accordingly, the dispenser 12 may dispense the containers 14 to the product display area 54 such that products 16 may be retrieved from the containers 14 by way of the access openings 34 (FIG. 3B) when the containers 14 are dispensed to the product display area 54.

Once all products 16 have been removed from the lower-most container 14′, the lower-most container 14′ may be removed from the dispenser 12. For example, the lower-most container 14′ may be removed from the dispenser 12 by pulling the container 14′ through the container dispensing opening 74. With the lower-most container 14′ removed, the next container 14″ (FIG. 1) may move to the lower-most position and, ultimately, to the product display area 54 by dropping onto the support deck 52 under the force of gravity.

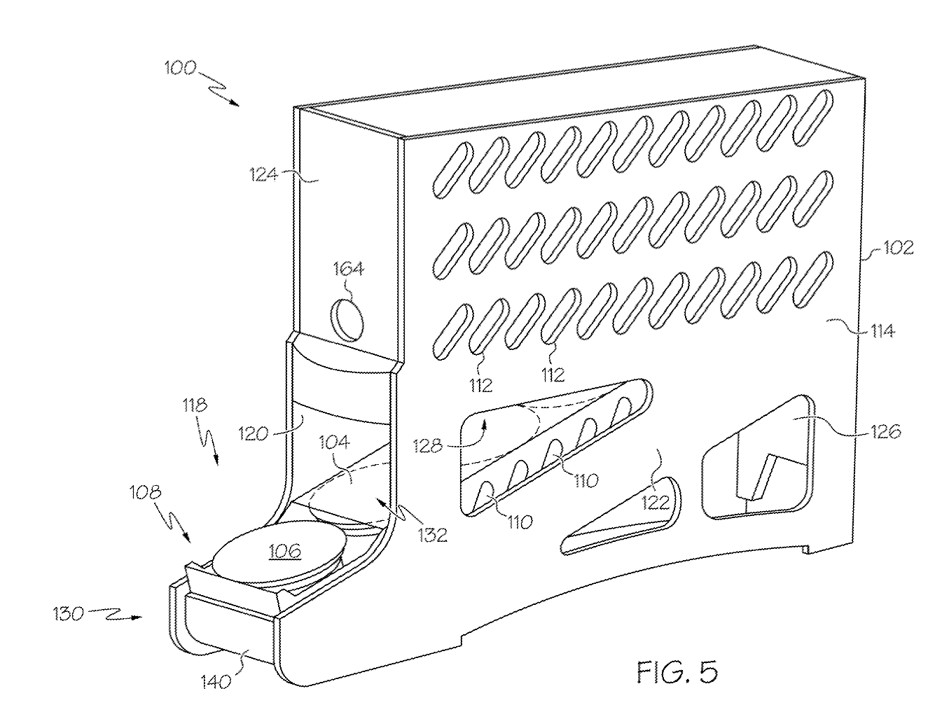

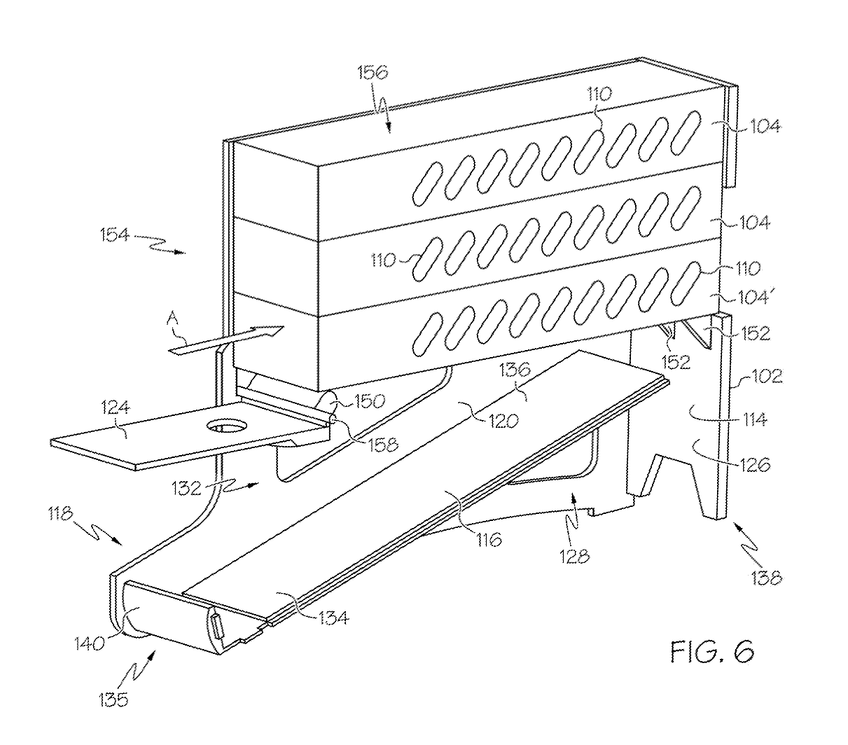

Referring to FIGS. 5 and 6, another embodiment of the disclosed product dispensing system, generally designated 100, may include a dispenser 102, a plurality of containers 104 and a plurality of products 106. Each container 104 may house an initial quantity of products 106, and may be loaded into the dispenser 102. The dispenser 102 may dispense the products 106 directly from the containers 104.

The containers 104 may be similar to the containers discussed above, and may include an access opening 108 (FIG. 5) sized and shaped to allow the products 106 housed in the container 104 to pass through the access opening 108.

Each container 104 may optionally include one or more ventilation openings 110. The ventilation openings 110 in the containers 104 may be configured to align with corresponding ventilation openings 112 in the dispenser 102. The ventilation openings 110, 112 may encourage air flow within the containers 104, which may be particularly advantageous when the containers 104 house products 106, such as yogurt cups, that require refrigeration.

The dispenser 102 may include a housing 114 and a support deck 116. The housing 114 may be sized and shaped to receive the containers 104, and may define a product display area 118. The support deck 116 may be received within the housing 114, and may direct the containers 104 and associated products 106 toward the product display area 118. Therefore, containers 104 may be loaded into the dispenser 102 and consumers may retrieve products 106 from the containers 104 by way of the product display area 118.

The housing 114 of the dispenser 12 may include a first (e.g., left) side wall 120, a second (e.g., right) side wall 122, a front wall 124 and a rear wall 126. The left side wall 120 may be laterally spaced from the right side wall 122, and may be generally parallel with the right side wall 122. The front wall 124 may be longitudinally spaced from the rear wall 126, and may be generally parallel with the rear wall 126. The side walls 120, 122, the front wall 124 and the rear wall 126 may define an internal volume 128 of the housing 114.

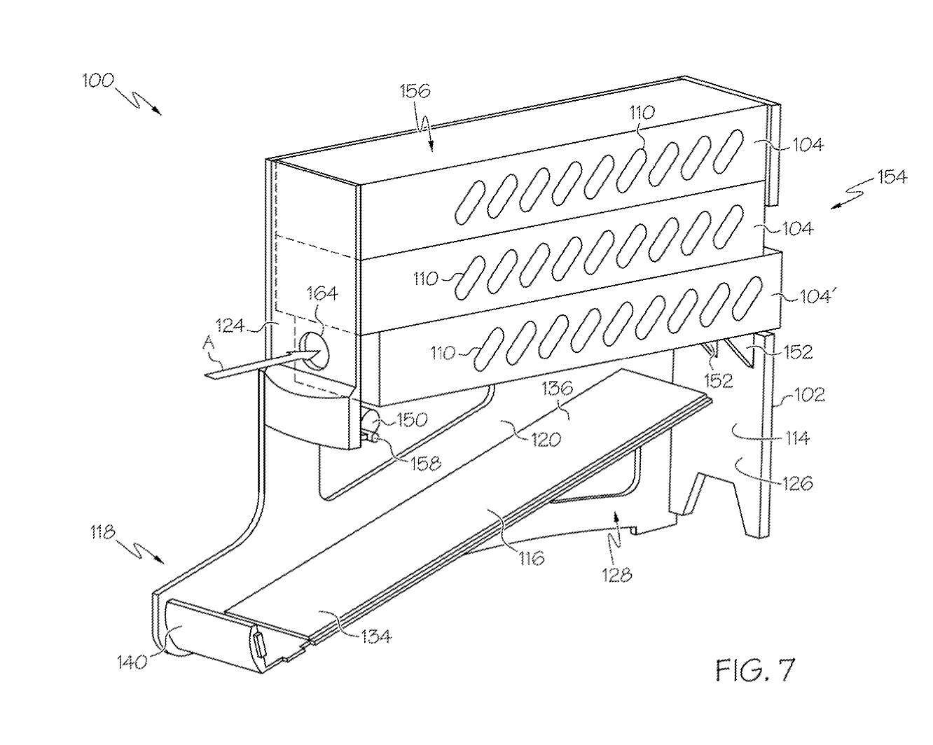

Referring to FIGS. 6 and 7, a front shelf member 150 may be connected to the front wall 124 and may laterally extend between the side walls 120, 122. The front shelf member 150 may protrude inward from the front wall 124 (i.e., toward the rear wall 126). While the front shelf member 150 is shown as a single piece member, the front shelf member may be comprised of multiple shelf members without departing from the scope of the present disclosure.

Rear shelf members 152 may be connected to the rear wall 126, and may protrude inward from the rear wall 126 (i.e., toward the front wall 124). While multiple rear shelf members 152 are shown, a single shelf member, like the front shelf member 150, may be used without departing from the scope of the present disclosure.

The front and rear shelf members 150, 152 may be position in the upper portion 154 of the housing 114 to support a plurality of containers 104 (e.g., three containers 104) in a generally horizontal configuration, as best shown in FIG. 6. Therefore, the internal volume 128 of the housing 114 may be sized and shaped to receive the containers 14 in a stacked and generally horizontal configuration.

The upper portion 154 of the housing 114 may define a container loading opening 156 that may open to the internal volume 128 of the housing 114. For example, the container loading opening 156 may be defined by the upper-most ends of the side walls 120, 122, the front wall 124 and the rear wall 126. Therefore, containers 104 may be loaded onto the shelf members 150, 152 by way of the container loading opening 156, such as by vertically lowering the containers 104 onto the shelf members 150, 152 through the container loading opening 156.

Still referring to FIGS. 6 and 7, the front wall 124 of the housing 114 may be pivotally connected to the dispenser 102 such that the front wall 124 may move between a closed configuration, as shown in FIG. 7, and an open configuration, as shown in FIG. 6. As one example, the front wall 124 may be connected to the front shelf member 150 with a hinge 158 that facilitates movement of the front wall between the open and closed configurations. As another example, the front wall 124 may be connected to the side walls 120, 122 at pivot points.

Optionally, the front wall 124 may be biased to the closed configuration shown in FIG. 7. For example, a biasing element, such as a spring, may be operatively connected to the front wall 124 and may urge the front wall 124 to the closed configuration.

Thus, containers 104 may be loaded onto the shelf members 150, 152 of the dispenser 102 by first moving the front wall 124 to the open configuration (FIG. 6) and, while the front wall is in the open configuration, horizontally urging the lower-most container 104′ onto the shelf members 150, 152 and then stacking additional containers 104 onto of the lower-most container 104′. Once the containers 104 have been loaded into the internal volume 128 of the housing 114, the front wall 124 may be moved to the closed configuration (FIG. 7) to enclose the internal volume 128.

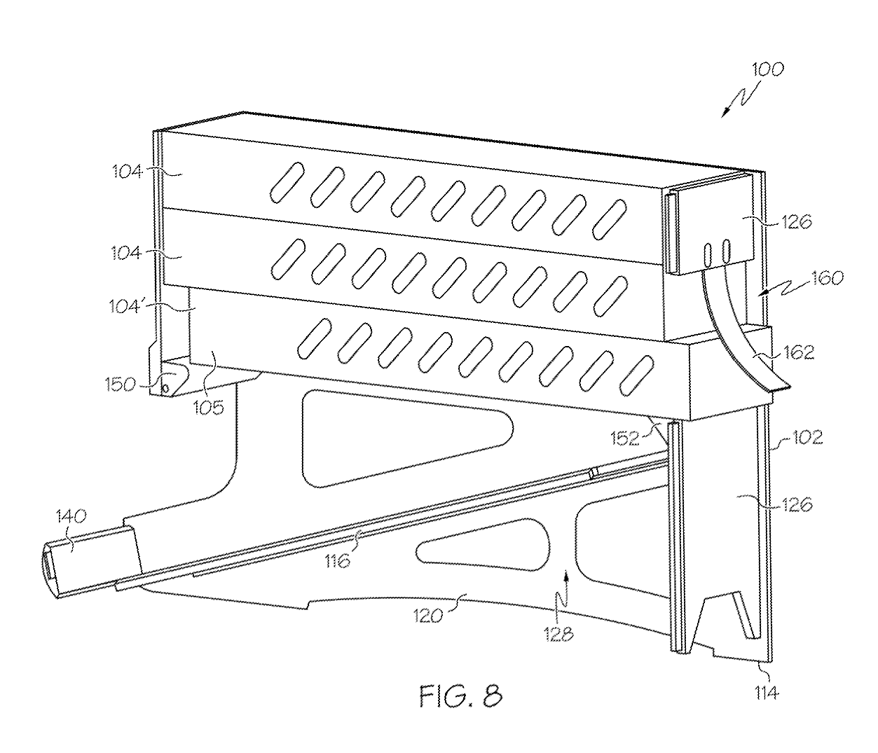

Referring to FIG. 8, the rear wall 126 of the housing 114 may define a container displacement opening 160 that opens to the internal volume 128 of the housing 114. The container displacement opening 160 may be formed in the upper portion 154 of the rear wall 126, such as immediately above the rear shelf members 152, such that the container displacement opening 160 is generally aligned with the lower-most container 104′ supported on the shelf members 150, 152. The container displacement opening 160 may be sized and shaped to allow the lower-most container 104′ to pass therethrough when a force (arrow A in FIGS. 6 and 7) is applied to the container 104′.

Optionally, a biasing member 162, such as a spring-loaded finger, may be positioned over the container displacement opening 160 to resist movement of containers 104 through the container displacement opening 160, thereby retaining containers 104 within the internal volume 128 of the housing 114. Therefore, the force (arrow A in FIGS. 6 and 7) required to urge a container 104′ through the container displacement opening 160 may be greater than the biasing force of the biasing member 162.

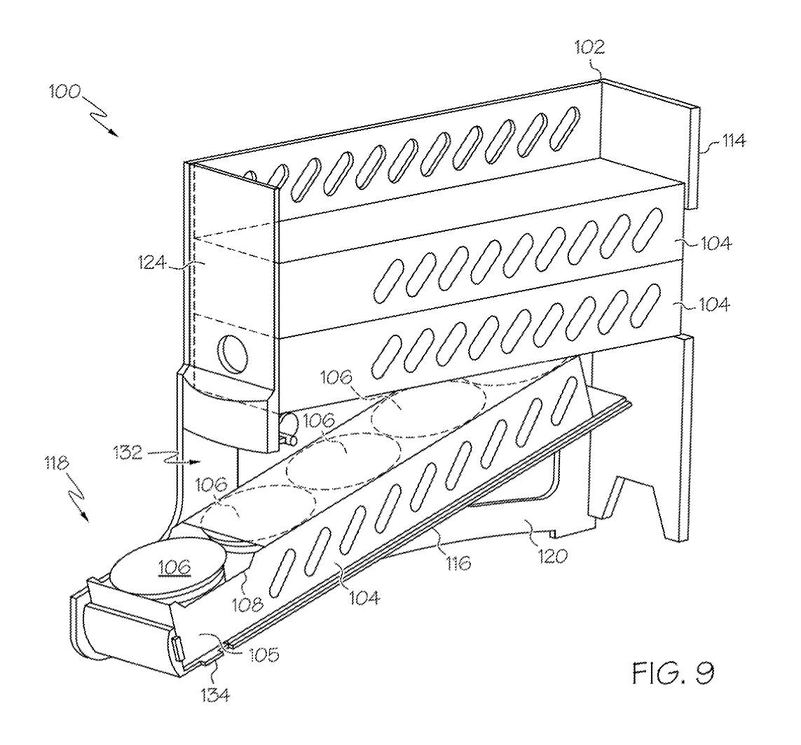

Referring to FIGS. 8 and 9, as the lower-most container 104′ supported on the shelf members 150, 152 is urged through the container displacement opening 160 in the direction shown by arrow A (FIGS. 6 and 7), the front end 105 of the container 104′ may become sufficiently displaced from the front wall 124 that the front end 105 disengages the front shelf member 150 (i.e., the front end 105 is no longer supported on the front shelf member 150). With the front end 105 of the container 104′ disengaged from the front shelf member 150, the container 104′ may drop down onto the support deck 116 under the force of gravity, as shown in FIG. 9.

Referring to FIG. 7, the front wall 124 of the housing 114 may define an engagement opening 164 that opens to the internal volume 128 of the housing 114. The engagement opening 164 may be formed in the upper portion 154 of the front wall 124 such that the engagement opening 164 is generally aligned with the lower-most container 104′ supported on the shelf members 150, 152. Therefore, the force (arrow A) required to urge the container 104′ through the container displacement opening 160 (FIG. 8) may be applied to the container 104′ by way of the engagement opening 164. For example, the force (arrow A) may be applied manually by inserting a finger, a probe or the like through the engagement opening 164.

Various alternatives to the engagement opening 164 are also contemplated. For example, the force (arrow A) required to urge the container 104′ through the container displacement opening 160 (FIG. 8) may be applied by a button, lever of the like connected to the dispenser 102, such as to the front wall 124 of the dispenser 102. Therefore, the force (arrow A) may be applied by actuating the button or lever rather than manually inserting a finger, a probe or the like through an engagement opening 164.

Referring back to FIGS. 5 and 6, the lower portion 130 of the housing 114 may define a container dispensing opening 132 that opens to the internal volume 128 of the housing 114 proximate the product display area 118. For example, the container dispensing opening 132 may be defined by the front wall 124 and the side walls 120, 122. Therefore, a container 104, or at least a portion of a container 104, may move from the internal volume 128 of the housing 114 to the product display area 118 by way of the container dispensing opening 132.

The support deck 116 of the dispenser 102 may be received in the internal volume 128 of the housing 114. As best shown in FIG. 6, the support deck 116 may laterally extend between the left and right side walls 120, 122, and may include a front end 134 that longitudinally extends toward the front end 136 of the housing 114 and a rear end 138 that longitudinally extends toward the rear end 138 of the housing 114.

The support deck 116 may be inclined from the front end 134 to the rear end 138 (i.e., the rear end 138 may be elevated relative to the front end 134). Therefore, containers 104 supported on the support deck 116 may be urged downward toward the front end 134 of the support deck 116 under the force of gravity.

A stop 140 may be positioned proximate the front end 134 of the support deck 116 to prevent containers 104 from moving beyond the front end 134 of the support deck 116. For example, the stop 140 may laterally extend between the side walls 120, 122 of the housing 114. Therefore, the stop 140 may retain containers 104 proximate the product display area 118 of the housing 114.

The product dispensing system 100 may be assembled by loading a plurality of containers 104 into the internal volume 128 of the dispenser 102 and onto the shelf members 150, 152 (FIGS. 6 and 7). In one implementation, the containers 104 may be vertically lowered onto the shelf members 150, 152 by way of the container loading opening 156. In another implementation, the containers 104 may be horizontally urged onto the shelf members 150, 152 by pivoting the front wall 124 of the dispenser 102 to the open configuration shown in FIG. 6.

With the containers 104 loaded onto the shelf members 150, 152, a force (arrow A in FIGS. 6 and 7) may be applied to the lower-most container 104′ supported on the shelf members 150, 152 to urge the container 104′ through the container displacement opening 160 (FIG. 8) until the container 104′ drops down onto the support deck 116. Then, as shown in FIGS. 5 and 9, gravity may urge the container 104′ toward the front end 134 of the support deck 116 such that the container 104′ (or at least the front end of the 104′) may pass through the container dispensing opening 132 to the product display area 118. The remaining containers 104 may remain in a generally horizontal configuration on the shelf members 150, 152 until they are urged through the container displacement opening 160 and caused to drop onto the support deck 116.

Thus, the dispenser 102 may dispense the containers 104 to the product display area 118 such that products 106 may be retrieved from the containers 104 by way of the access openings 108 in the containers 104 when the containers 104 are dispensed to the product display area 118.

Accordingly, the disclosed product dispensing systems and methods may dispense containers to a product display area, thereby allowing consumers to retrieve products directly from the containers. As such, the disclosed product dispensing systems and methods may be used to dispense products that may not be compatible with product dispensing systems that require products to roll.

Although various embodiments of the disclosed product dispensing system and method have been shown and described, modifications may occur to those skilled in the art upon reading the specification. The present application includes such modifications and is limited only by the scope of the claims.

What is claimed is:

1. A product dispensing system comprising:
a dispenser comprising:
a housing comprising a front wall, a rear wall, a first side wall and a second side wall that define an internal volume and a product display area, wherein upper portions of said front wall, said rear wall, said first side wall and said second side wall define a container loading opening;
a support deck received in said internal volume, said support deck comprising a first end and a second end, wherein said first end extends toward said product display area, and wherein said second end is elevated relative to said first end;
a first shelf member connected to said front wall above said first end of said support deck; and
a second shelf member connected to said rear wall above said second end of said support deck;.
a container received in said internal volume through said container loading opening and supported on said support deck, said container defining an access opening, wherein said support deck directs said container toward said first end such that said access opening is aligned with said product display area;
a plurality of products initially housed in said container; and
a second container received in said internal volume through said container loading opening, said second container being supported on said first and second shelf members above said container.

2. The system of claim 1 wherein said housing further defines a container dispensing opening proximate said product display area.

3. The system of claim 2 wherein said container is sized and shaped to pass through said container dispensing opening.

4. The system of claim 2 wherein said container at least partially extends through said container dispensing opening when said access opening is aligned with said product display area.

5. The system of claim 1 wherein said dispenser further comprises a stop proximate said first end, wherein said stop at least partially defines said product display area.

6. (canceled)

7. The system of claim 1 wherein said support deck laterally extends between said first side wall and said second side wall.

8. The system of claim 1 wherein said front wall defines a container dispensing opening proximate said product display area.

9. The system of claim 1 wherein at least a portion of said front wall is pivotally connected to said housing and moveable between an open configuration and a closed configuration.

10. The system of claim 9 wherein said front wall provides access to said internal volume when in said open configuration.

11. The system of claim 1 further comprising a third container received in said internal volume through said container loading opening.

12. The system of claim 11 wherein said third container is stacked directly on top of said second container.

13. (canceled)

14. The system of claim 1 wherein said shelf members support said second container in a generally horizontal configuration.

15. The system of claim 1 wherein said housing defines a container displacement opening aligned with said second container.

16. The system of claim 15 wherein said second container becomes disengaged from said shelf members when said second container is urged a distance through said container displacement opening.

17. The system of claim 1 wherein said plurality of products comprise a plurality of yogurt cups.

18. A method for dispensing products comprising the steps of:
providing a plurality of containers, each container of said plurality of containers housing a plurality of products and defining an access opening;
providing a dispenser comprising a housing that defines an internal volume and a product display area, a support deck received in said internal volume, said support deck comprising a first end and a second end, wherein said first end extends toward said product display area, and wherein said second end is elevated relative to said first end, and first and second shelf members positioned above said support deck;.
receiving said plurality of containers in said internal volume, said plurality of containers being supported on said shelf members such that each container of said plurality of containers is stacked directly on top of a subjacent container
positioning a lower-most container of said plurality of containers onto said support deck, wherein said support deck directs said access opening of said lower-most container to said product display area.

19. The method of claim 18 wherein said receiving step comprises stacking said plurality of containers in a substantially horizontal configuration.

20. The method of claim 18 further comprising the step of withdrawing a product of said plurality of products from said lower-most container through said access opening.

21. A product dispensing system comprising:
a dispenser comprising:
a housing that defines an internal volume and a product display area;
a support deck received in said internal volume, said support deck comprising a first end and a second end, wherein said first end extends toward said product display area, and wherein said second end is elevated relative to said first end; and
first and second shelf members positioned above said support deck;
a container received in said internal volume and supported on said support deck, said container defining an access opening, wherein said support deck directs said container toward said first end such that said access opening is aligned with said product display area;
a plurality of products initially housed in said container;
a second container received in said internal volume and supported on said shelf members in a generally horizontal configuration; and
a second plurality of products initially housed in said second container.
